(19) United States
(12) Patent Application Publication
(10) Pub. No.: US 2011/0067082 A1
(43) Pub. Date: Mar. 17, 2011

(54) SYSTEM AND METHOD FOR REMOTE LIVE AUDIO-VISUAL PRODUCTION

(75) Inventor: Kyle Walker, Geneva, IL (US)

(73) Assignee: Weigel Broadcasting Co., Chicago, IL (US)

(21) Appl. No.: 12/858,337

(22) Filed: Aug. 17, 2010

Related U.S. Application Data
(60) Provisional application No. 61/274,527, filed on Aug. 17, 2009.

(51) Int. Cl. H04N 7/173; G06F 15/16

(52) U.S. Cl. 725/114; 709/231

(57) ABSTRACT

The disclosure presents a system for facilitating transmission of live audio-visual content between a first location and a second remote location. The system includes a portable communication apparatus having an input/output switch; an audio matching converter; a codec in communication with the input/output switch for receiving the live video content signal transmitted from the input/output switch; and a 4G or higher wireless modem in communication with the codec. The system also includes a terminal communication apparatus having a carrier receiving unit; a codec in communication with the carrier receiving unit; an audio matching converter in communication with the codec; and an input/output switch.

### CROSS REFERENCE TO RELATED APPLICATION

This application claims priority from U.S. Provisional Patent Application Ser. No. 61/274,527, filed Aug. 17, 2009, which is hereby incorporated by reference herein in its entirety.

### TECHNICAL FIELD

This invention relates generally to a system and method for facilitating a remote live audio visual broadcast production. More particularly, the present invention relates to a system and method for allowing a remote live video crew, such as a live on-site reporter, to communicate and receive broadcast quality audio-visual content to and from two locations.

### SUMMARY OF THE INVENTION

The present invention is directed to a system for facilitating transmission of live audio-visual content between a first location and a second remote location. The system includes a portable communication apparatus for facilitating transmission of live audio-visual content between a first location and a second remote location. The portable communication apparatus has as input/output switch for receiving a live video content signal. The portable communication apparatus also has an audio matching converter for receiving a live audio content signal and for unbalancing the live audio content signal. The portable communication apparatus further includes a codec in communication with the input/output switch for receiving the live video content signal transmitted from the input/output switch and for receiving the unbalanced live audio content signal, and for encoding the live visual content signal and the unbalanced live audio content signal into a UDP streaming content signal. The portable communication apparatus also has a router in communication with the codec and the wireless modem for receiving the UDP streaming content and for routing the UDP streaming content to the wireless modem. A 4G or higher wireless modem is in communication with the codec for receiving the UDP streaming content and for transmitting the UDP streaming content to a remote terminal device at a second remote location over a 4G or higher network. The portable communication apparatus further includes a portable battery supply in communication with and for powering at least the input/output switch, the audio matching converter, the codec and the wireless modem.

The portable communication apparatus receives the live audio content signal and the live video content signal from a camera capturing live audio-visual content. A monitor is provided in communication with the input/output switch for receiving a live video signal from the input/output switch for viewing the live audio-visual content prior to transmission of the live audio-visual content through the wireless modem. The wireless modem transmits the UDP streaming content of the live audio-visual content to a broadcast station over a 4G or higher wireless network, and the wireless modem receives a broadcast signal from the broadcast station. The codec then receives the broadcast signal in UDP streaming format and decodes the broadcast signal into a live broadcast video content signal. The input/output switch receives the live broadcast video content signal from the codec and the input/output switch communicates the live broadcast video content signal to the monitor in communication with the input/output switch for viewing the live audio-visual content as broadcasted by the broadcast station, through the monitor. The codec further decodes the broadcast signal into a live unbalanced broadcast audio content signal. The audio matching converter converts the live unbalanced broadcast audio content signal received from the codec into a live balanced broadcast audio content signal, and the input/output switch receives the balanced broadcast audio content signal for communicating the balanced broadcast audio content signal to an audio generation device. The broadcast station broadcasts the live audio-visual content through a broadcast signal. The broadcast signal can be sent by radio frequency transmission signal, cable transmission signal, and/or an interne protocol transmission signal.

In one aspect of the present invention, the codec is configured to determine a transmission rate for encoding the live visual content signal and the unbalanced live audio content signal into the UDP streaming content signal, for transmitting the UDP streaming content to the remote terminal device at the second remote location over a 4G or higher network. The codec determines the transmission rate based on the quality of transmission of the UDP streaming content. The codec determines the quality of the transmission of the UDP streaming content by determining a transmission error rate and wherein the codec determines the transmission rate by comparing the transmission error rate to a predetermined error threshold. The codec can also determine or set a higher transmission rate if the transmission error rate is less than the predetermined error threshold and a lower transmission rate if the transmission error rate is greater than the predetermined error threshold. In one embodiment, the codec includes a memory, a processor and program code. The codec can also determine the transmission rate by determining a transmission error rate and looking up a respective transmission rate from stored transmission rate table.

The portable communication apparatus can also have a logo generator in communication with the input/output switch for generating a logo signal and for transmitting the logo signal to the input/output switch. The input/output switch is configured to transmit the logo signal alone or together with the live video content signal to the codec. The logo generator further includes an IP input connector for receiving a logo graphic for use in generating the logo signal, and the logo generator further can have a memory for storing the logo graphic.

In a further aspect of the present invention, the codec is further configured to encode priority meta data information representing that the UDP streaming content signal is live audio-visual content for communication to a broadcast carrier. The portable communication apparatus transmits the priority meta data to a first communication apparatus configured to receive the priority meta data and determine that the source of the UDP streaming is a priority source based on the priority meta data. The first communication apparatus is further configured to transmit the UDP streaming content signal over a priority bandwidth of the 4G or higher network if the first communication apparatus determines that the source of the UDP streaming content signal is a priority source.

The system also includes a terminal communication apparatus for facilitating transmission of live audio-visual content between a first location and a second remote location. The terminal communication apparatus includes a carrier receiving unit, such as a 4G or higher wireless modem, for receiving UDP streaming content, representing live audio-visual content, from a remote portable communication apparatus at a first remote location over a 4G or higher network. The terminal communication apparatus also includes a router in communication with a codec and the carrier receiving unit for receiving the UDP streaming content and for routing the UDP streaming content to the codec. The codec is in communication with the carrier receiving unit and is provided for receiving the UDP streaming content, for decoding the UDP streaming content signal into a broadcast video content signal, and for decoding the UDP streaming content into an unbalanced broadcast audio content signal. The terminal communication apparatus further includes an audio matching converter in communication with the codec for receiving the unbalanced broadcast audio content signal, for balancing the unbalanced broadcast audio content signal into a balanced broadcast audio content signal, and for transmitting the balanced broadcast audio content signal to a broadcast signal generation device. The terminal communication apparatus further includes an input/output switch for receiving the broadcast video content signal, and for transmitting the broadcast video content signal to the broadcast signal generation device. A monitor is provided and is in communication with the input/output switch for receiving a broadcasted video signal from the input/output switch for viewing the broadcasted audio-visual content as it is being broadcasted by a broadcast station at the second location.

In a further aspect of the present invention, a return feed is provided back to the portable communication apparatus. The input/output switch receives a broadcast video signal and transmits the broadcast video signal to the codec. The audio matching converter is provided for receiving the broadcast audio signal and for unbalancing the broadcast audio signal into unbalanced broadcast audio signal. The codec receives the unbalanced broadcast audio signal and the broadcast video signal, and encodes the unbalanced broadcast audio signal and the broadcast video signal into a broadcast signal in UDP streaming format, representing broadcasted video content. In one embodiment, the codec of the terminal communication apparatus can have similar features as the codec of the portable communication apparatus.

In another aspect of the present invention, the portable communication apparatus for facilitating transmission of live audio-visual content between a first location and a second remote location, includes and/or is housed within an apparatus including a housing having a first housing portion and a second housing portion forming a housing interior. The housing further includes a plurality of connectors disposed thereon, the plurality of connectors including a video input connector, a video output connector, a first and second audio input connector and a first and second audio output connector. The apparatus further has a video monitor having a video display, the video monitor being disposed in an opening in the housing, whereby the video display is viewable from the exterior of the housing and a portion of the video monitor is disposed within the housing interior. The apparatus further includes a number of components disposed in the housing including a video switch that is communicatively connected to the video input connector, the video output connector, and the video monitor; an audio matching convertor that is communicatively connected to the first and second audio input connectors and the first and second audio output connectors; a codec that is communicatively connected to the audio matching convertor and the video switch; a modem; and a router disposed in the housing interior, wherein the router is communicatively connected to the codec and the modem.

In a further aspect of one embodiment of the apparatus, the first housing portion has a first housing portion edge forming a plane and having a channel formed therein and the second housing portion has a second housing portion edge, the second housing portion edge forming a plane. The first and second housing portions are connected by a hinge and the housing also has a gasket located in the channel of the first housing portion edge. When the first and second housing portions are rotated about an axis formed by the hinge into a closed position such that the first and second housing portions are in the closed position, the gasket contacts the second housing portion edge, thereby making an interface formed by the first housing portion and the second housing portion water resistant.

Another embodiment of the present invention is directed to a wearable portable communication apparatus for facilitating transmission of live audio-visual content between a first location and a second remote location, the apparatus having a housing including a first housing portion and a second housing portion forming a housing interior. The housing further includes a plurality of connectors disposed thereon, the plurality of connectors including a video input connector, a video output connector, a first and second audio input connector and a first and second audio output connector. The apparatus further has a video monitor having a video display, the video monitor being disposed in an opening in the housing, whereby the video display is viewable from the exterior of the housing and a portion of the video monitor is disposed within the housing interior. The apparatus further includes a number of components disposed in the housing including a video switch that is communicatively connected to the video input connector, the video output connector, and the video monitor; an audio matching convertor that is communicatively connected to the first and second audio input connectors and the first and second audio output connectors; a codec that is communicatively connected to the audio matching convertor and the video switch; a modem; and a router disposed in the housing interior, wherein the router is communicatively connected to the codec and the modem. The wearable portable communications apparatus may further have a first strap attached to the housing for attaching the apparatus around a user's waist. In another embodiment, the wearable portable communications apparatus may further have a first and second strap attached to the housing, whereby the first and second straps can be fitted over a user's shoulders for attaching the apparatus to the user.

Other systems, methods, features, and advantages of the present invention will be, or will become, apparent to one having ordinary skill in the art upon examination of the following drawings and detailed description. It is intended that all such additional systems, methods, features, and advantages included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a schematic block diagram of one embodiment of each of the portable communication apparatus and the terminal communication apparatus of the present invention.

FIG. 2 is a block diagram of one embodiment of the system for facilitating transmission of live audio-visual content between a first location and a second remote location of the present invention.

FIG. 3 is a block diagram of another embodiment of the system for facilitating transmission of live audio-visual content between a first location and a second remote location of the present invention.

FIG. 4 front/top view of one embodiment of the portable communication apparatus of FIG. 1.

FIG. 5 is side view of the portable communication apparatus of FIG. 4, with components removed.

FIG. 6 is a side view of the portable communication apparatus of FIG. 5.

FIG. 7 is a top view of the interior of the portable communication apparatus of FIG. 4.

FIG. 8 is top view of a portion of the interior of the portable communication apparatus of FIG. 4.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

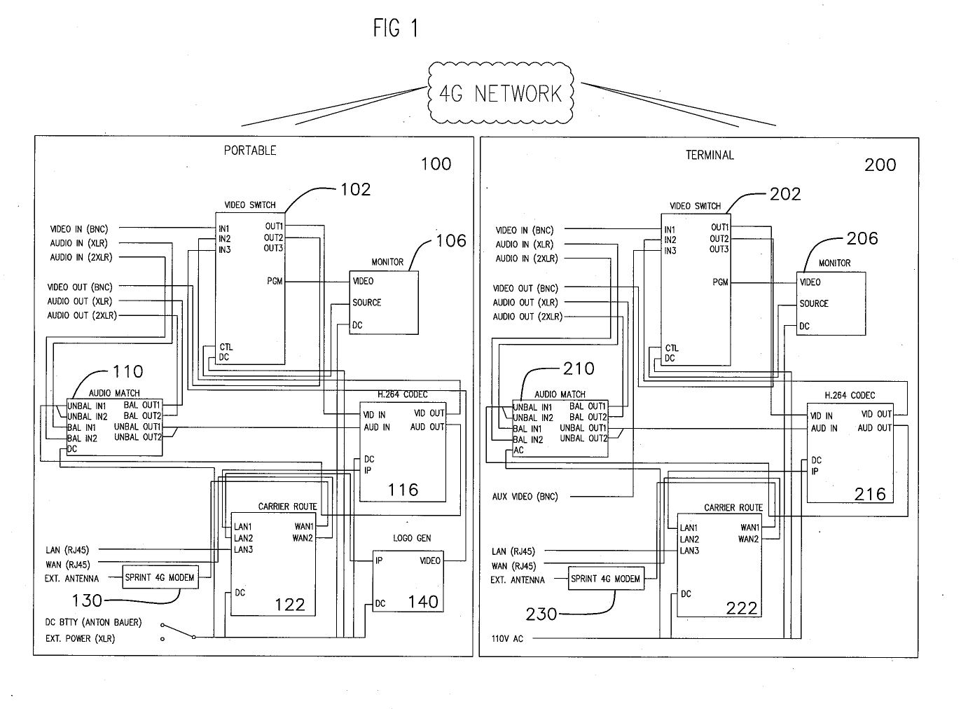

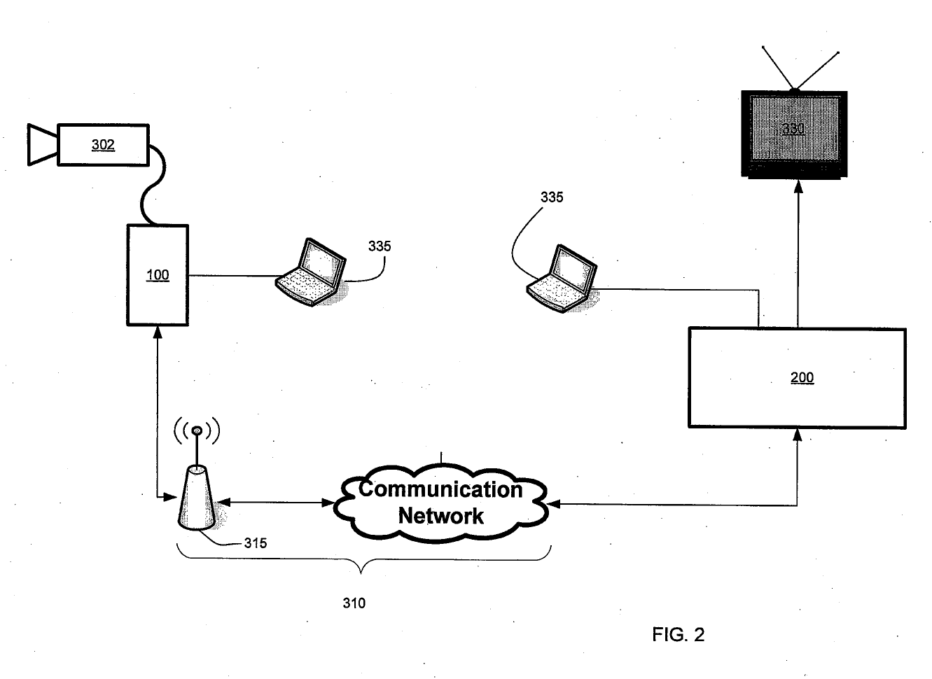

The present invention is directed to a system for facilitating transmission of live audio-visual content between a first location and a second remote, which is generally shown in FIG. 2, and described below. As shown in FIGS. 1-3, the system generally includes is a portable communications apparatus 100 and a terminal communications apparatus 200, that are capable of delivering broadcast quality video to and from two locations. A wireless carrier should be capable of delivering data rates in at least the range of 300-2300 kbps between the portable communications apparatus 100 and the terminal communications apparatus 200.

As shown in FIG. 1, in one embodiment, each of the portable communication apparatus 100 and terminal communication apparatus 200 includes an input/output switch 102, 202 or video switch. A video switch can also be called a vision mixer, video mixer, or production switcher, which is a device used to select between several different video sources and in some cases composite (mix) video sources together and add special effects. One example of the input/output switches 102, 202 is a model RU-VSX4 video switcher from Radio Design Labs, Inc. (d/b/a RDL) of Prescott, Ariz. In the embodiment shown in FIG. 1, the input/output switches 102, 202 have three video inputs, three video outputs, a program output, and a control input. The input/output switch 102 of the portable communication apparatus 100 has a DC power input, while the input/output switch 202 of the terminal communication apparatus 200 has an AC power input. The video input and output connections can be BNC (Bayonet Neill-Concelman) connectors, which are used for terminating coaxial cable and can handle frequencies of up to at least 4 GHz.

The portable communication apparatus 100 and the terminal communication apparatus 200 each also include a video monitor 106, 206. The video monitors 106, 206 shown in FIG. 1 each have a video input and a source output. The video monitor 106 of the portable communication apparatus 100 has a DC power input, while the video monitor 206 of the terminal communication apparatus 200 has an AC power input. In one embodiment, the video monitor 106 of the portable communication apparatus 100 is a 10.4 inch on-board LCD monitor, while the video monitor 206 of the terminal communication apparatus 200 is a 5 inch on-board LCD monitor.

The portable communication apparatus 100 and the terminal communication apparatus 200 each also include an audio matching converter 110, 210. Audio matching converters address the concept of balanced audio, which is a method of interconnecting audio equipment using impedance-balanced lines. This type of connection is significant in production because it allows for the use of long cables while reducing susceptibility to external noise. Balanced connections can use three-conductor connectors, such as XLR, as will be described below. Microphones typically operate at low voltage levels and some with high output impedance, which makes long microphone cables especially susceptible to electromagnetic interference. Microphone may therefore require a balanced interconnection, which cancels out most of the induced outside noise. One example of the audio matching converters 110, 210 is a 2-way stereo converter, model MB15 Promatch from Rolls Corporation of Salt Lake City, Utah. In the embodiment shown in FIG. 1, the audio matching converters 110, 210 each have two unbalanced inputs, two balanced inputs, two balanced outputs and two unbalanced outputs.

In the embodiment shown in FIG. 1, the balanced and unbalanced input and outputs of the audio matching converters 110, 210 can utilize XLR connectors. As mentioned herein above, XLR connectors are a particular type of electrical connector design. XLR plugs and sockets can be used in professional audio and video electronics cabling applications, including for microphones. The audio matching converter 110 of the portable communication apparatus 100 has a DC power input, while the audio matching converter 210 of the terminal communication apparatus 200 has an AC power input. In one embodiment of the portable communication apparatus 100, the unbalanced outputs are connected and transmitted to a headphone amplifier circuit (not shown) and then onto to a ¼ inch stereo connector mounted to a portable housing, described below. A 10 k adjustable potentiometer can be provided to allow for volume level adjustment to the headphone amplifier circuit. Likewise, in one embodiment of the terminal communication apparatus 200, the unbalanced outputs are connected to and transmitted to a headphone amplifier circuit (not shown) and then onto a ¼ inch stereo connector mounted to the front of the terminal communication apparatus 200. A 10 k adjustable potentiometer can also be provided to allow for volume level adjustment to the headphone amplifier circuit.

The portable communication apparatus 100 and the terminal communication apparatus 200 each also include a codec 116, 216. A codec is a device or computer program capable of encoding and/or decoding a digital data stream or signal. The word codec is short for ‘compressor-decompressor’ or ‘coder-decoder’. Multimedia data streams typically contain both audio and video, and often some metadata that permit synchronization of audio and video. Each of these three streams may be handled by different programs, processes, or hardware. H.264 is one type of codec, and implements a block-oriented motion-compensation-based codec standard. One example of the codecs 116, 216 is a model VSIP2 encoder and a ViPix decoder from ATEME S.A. of Bievres Cedex, France. In the embodiment shown in FIG. 1, the codecs 116, 216 each have a video input, an audio input, a video output, an audio output, and an internet protocol (IP) input/output port. The codec 116 of the portable communication apparatus 100 has a DC power input, while the codec 216 of the terminal communication apparatus 200 has a DC power input. In the embodiment shown in FIG. 1, the codecs 116, 216 encode analog video and audio signals into an H.264 UDP stream, and decode an H.264 UDP stream into analog video and audio signals. UDP or User Datagram Protocol is one of the members of the Internet Protocol Suite, the set of network protocols used for the Internet. With UDP, computer applications can send messages, sometimes referred to as datagrams, to other devices on an Internet Protocol (IP) network without requiring prior communications to set up special transmission channels or data paths. UDP uses a simple transmission model without implicit hand-shaking dialogues for guaranteeing reliability, ordering, or data integrity. In one embodiment of the codecs 116, 216 of FIG. 1, the codecs 116, 216 can each include a codec memory, a codec processor and program code running on the codec processor for performing various functions, as described herein below.

The codecs 116, 216 can be programmed and/or adapted to perform dynamic bit rate adaption. In particular, the link quality between encoder and decoder can change during communications. In turn, the bit-rate is adapted/modified to correspond to the link quality. A typical bit-rate is 1000 Kbps (kilo bits per seconds). When the link quality is poor, the bit-rate can decrease down to 300 Kbps in 100 Kbps steps. When the link quality is good, the bit-rate can increase up to 2200 Kbps in 100 Kbps steps. In one embodiment, when the encoder starts up, the bit rate is set at 1000 Kbps, then the encoder is adapted to thereafter adapt the bit-rate according to the link quality.

In one embodiment, the encoder and/or decoder can activate an LED when data is sent/received in order to provide an indication to the user/operator that data is being transmitted. The rate of the blinking can be modified to reflect the bit-rate: the higher the bit-rate, the faster the blinking will be, also indicating that the high bit-rate is equivalent to a good ‘signal strength’ or link quality. The encoder and/or decoder can include a graphical user interface which displays HTML programmed/configured interface screens and information. The GUI can be updated every two seconds, and can display the numerical value of the received bit rate. A progression bar can also be used to display the bit rate.

In one embodiment, the encoder and/or decoder can each be programmed/adapted to carry out a bit rate adaptation algorithm. In one form of the algorithm or process, every 2 seconds or less (the period can be configurable), an 8 kB packet “beacon” is sent to the decoder to assist in estimating network bandwidth and packet loss ratio. This “beacon” packet can be embedded in a “picture” as user data or data that is a part of the data that used to establish the visually transmitted information. As such, the “beacon” packet has a transmission path which is the same as the video data. However, the “beacon” packet is transmitted as a burst, whereas the actual compressed video data is transmitted smoothly at the defined rate.

As indicated above, the decoder can be configured in software to compute the available bandwidth and instruct the encoder to change the video bit-rate accordingly, using a UDP connection (D2E message) in one embodiment. The transmission bit rate of the “beacon” can be 3 Mbps in one embodiment, regardless of the video bit rate. Under optimal transmission conditions, the reception time of the beacon about 21.8 ms. The chosen bit rate for the video will be:

Bit Rate=(Beacon size in bits)/(Reception time in seconds)

The Bit Rate can be capped at [300 kbps, 2.2 Mbps] and averaged over 4 consecutive measurements. The rate overhead of the “beacon” can be 32 kbps, which is considered as negligible compare to the video. The rate overhead has a two second refresh rate, which implies that the transmission conditions don't change abruptly.

Latency should be considered within audio/visual transmission. Several parameters have an impact on the end-to-end latency, including at least encoding time, compressed buffer time (CPB), transmission delay, and/or decoding time. Combined encoding and decoding time are typically below 400 ms. Excluding the network transmission time, the end-to-end delay is then approximately:

Delay=Compressed buffer time+400 ms

A buffer of this size is preferable, and used to “smooth out” the encoder “bursty” output. The buffer can be a fixed size buffer, which has a 300 ms duration at the maximum bit rate. Decreasing this value has a significant negative impact on video quality. In an embodiment with a fixed buffer, the buffer delay scales with the transmission bit rate. In such an embodiment, it is not likely feasible to change the buffer size in operation, as the data stream would not be compliant because at least some compressed data could be lost. Therefore, the end-to-end delay can be estimated as:

Delay=300 ms*Maximum_bitrate/Transmission_bitrate+400 ms

In one preferable embodiment, the end-to-end delay is about 700 ms. Assuming a maximum bit rate of 2.2 Mbps and a transmission bit rate of 300 kbps (the worst case), the delay is approximately 2.6 s. In such an embodiment, it is not contemplated that much can be done to improve this worst case without breaking the stream when adapting the encoding rate. One option is to limit bit rate values when the transmission conditions are known. For example, if the maximum bit rate is set to 1 Mbps, the worst case scenario with a 300 kbps transmission rate is a delay of 1.4 s. As another example, if the maximum bit rate is set to 2.2 Mbps, the worst case scenario with a 1 Mbps transmission rate is a delay of 1.06 s.

In one embodiment, the encoder is an RTP server and the decoder is an RTP client, where transmissions occur using RTP/UDP, as set forth herein above. The video can be encoded in H.264, baseline, or main profile, with a video sampling frequency of 13.5 MHz to enable the acquisition of 29.97 Hz analog video. The frame aspect ratio on the encoder input can be 4/3 or 16/9. Video resolutions can be at least 720×480, 720×240 or 352×240 @ 30 Hz. Thus, pixel aspect ratio is adjustable and transmitted accordingly in the video stream. In one embodiment, the decoder does not indicate the frame aspect ratio, nor does the decoder add horizontal or vertical black bars. Excluding network loss cases, the video stream is a single sequence. Thus, frame-rate can be changed by duplicating the same acquired frames on the encoder input (duplicated frames can be encoded at a very low bit rate). In one embodiment, audio can encoded in AAC-LC in fixed-mono. The bit rate is adapted and/or determined automatically from the sampling frequency. For example, with a sampling rate of 48 kHz, the bit rate is automatically configured at 64 kbps, which provides a near-CD audio quality.

The portable communication apparatus 100 and the terminal communication apparatus 200 can each also include a router 122, 222. A router is a network device that is used to allow access to the Internet or a computer network through a cabled or wireless connection. It can function in a wired LAN (local area network), in a wireless only LAN, or in a mixed wired/wireless network. Most current wireless routers have the following characteristics: 1) LAN ports, which function in the same manner as the ports of a network switch; 2) WAN ports, to connect to a wider area network. The routing functions are filtered using a WAN port; 3) Wireless antennae, which allow connections from other wireless devices (NICs (network interface cards), wireless repeaters, wireless access points, and wireless bridges, for example).

One example of the routers 122, 222 is a model MBR1000 from Cradlepoint, Inc. of Boise, Id. In the embodiment shown in FIG. 1, the routers 122, 222 each have three local area network (LAN) input/output connections and two wide area network (WAN) input/output connections. The router 122 of the portable communication apparatus 100 has a DC power input, while the router 222 of the terminal communication apparatus 200 has an AC power input. In one embodiment of the portable communication apparatus 100 and the terminal communication apparatus 200, the routers 122, 222 are wireless carrier routers which automatically hunt for the wireless carrier's network. Should the wireless network be unavailable, the routers 122, 222 can be configured to use a wired public internet interface that can be plugged into an Ethernet port located on the housing of the portable communication apparatus 100. For the router 222 of the terminal communication apparatus 200, a wired public internet interface can be plugged into the front or rear Ethernet ports located on the terminal communication apparatus 200. This mode of operation can be disabled to prevent switching to the public internet or left enabled for backup purposes. A POE Ethernet port can be located on the rear of the terminal communication apparatus 200 and can be used to connect to an integrated wireless carrier router/antenna that is mounted outdoors and fine tuned for maximum signal from the wireless carrier's system.

The portable communication apparatus 100 and the terminal communication apparatus 200 can each also include a 4G or higher wireless modem 130, 230, or a combination. In one embodiment, a plurality of 3G cards can be bonded together to form an equivalent 4G or higher wireless modem 130, 230, which shall be considered to be included within the definition of 4G or higher wireless modem 130, 230. Alternatively, a plurality of 4G cards can be bonded together to form an equivalent 4G plus (higher than 4G) wireless modem 130, 230. The wireless modems 130, 230 can each have a TNC external antenna connector. The modem 130 of the portable communication apparatus 100 can include a 6″ whip antenna mounted to the housing of the portable communication apparatus 100 for optimum reception to the wireless carrier. TNC (threaded Neill-Concelman) connectors are a threaded version of a BNC connector. A TNC connector has a 50Ω impedance and operates best in the 0-11 GHz frequency spectrum. It has better performance than the BNC connector at microwave frequencies. A 75-ohm series can also be used.

The portable communication apparatus 100 can also include a logo generator 140 that can be used to generate a static logo for displaying a broadcast station's logo or other logo comprising an advertisement. In the embodiment shown in FIG. 1, the logo generator 140 has an IP input/output connector, a video output and DC power input.

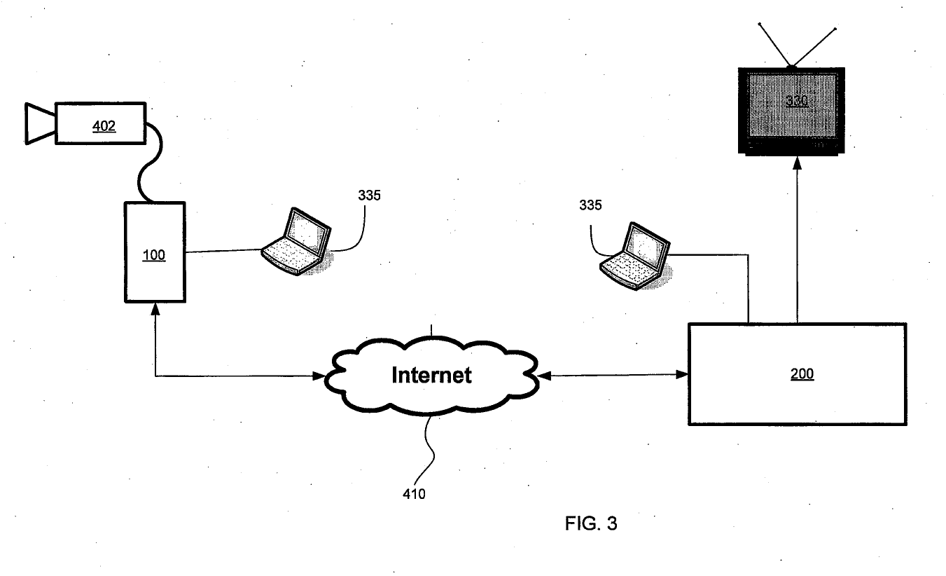

The various inputs, outputs and/or connections interconnect the input/output switches 102, 202, the monitor 106, 206, the audio matching converters 110, 210, the codecs 116, 216, the routers 122, 222, the modems 130, 230, and/or the logo generator 140 to one another within the portable communication apparatus 100 and/or the terminal communication apparatus 200 as is shown in FIG. 1. With additional reference to FIGS. 2 and 3, the following sets forth at least a portion of the operation of one embodiment of the system, including the portable communication apparatus 100 and the terminal communication apparatus 200 shown in FIG. 1. In general, the system can deliver broadcast quality video to and from two locations using the portable communication apparatus 100 and the terminal communication apparatus 200 installed at each of two locations. The portable communication apparatus 100 will typically be connected to a camera 302, 402 located “in the field” remote from a broadcasting or television station. The terminal communication apparatus 200 will typically be located at the broadcasting or television station, or the primary location where remote live audio-visual content is received. A wireless carrier communication network 310 and/or wired internet communications service provider network 410 connects the portable communication apparatus 100 and the terminal communication network 200 to one another, thereby facilitating transmission of live audio-visual content between the camera at the first location and the broadcast station at the second remote location relative to the first location. In one preferred embodiment of the present invention for maximum quality and reliability, the portable communication apparatus 100 and the terminal communication network 200 should utilize the wireless carrier communication network 310. As will be described in greater detail below, the wireless carrier communication network 310 can have a special QOS (Quality of Service) tier and/or bandwidth for customers who use the system of the present invention, which will provide the maximum bandwidth while routing the live audio-visual content data traffic on a priority basis on the wireless carrier communication network 310. In this configuration, the portable communication apparatus 100 can travel throughout a coverage area of the wireless carrier communication network 310 without the need to work (capture live audio-visual content) within the range of public internet wires, microwave antennas, satellite uplink trucks, etc. However, if the portable communication apparatus 100 is unable to connect to the wireless carrier communication network 310, the system and portable communication apparatus 100 is configured to connect to the wired internet communications service provider network 410 to deliver the live audio-visual content signal to and from the terminal communication apparatus 200 and broadcasting station. As mentioned, in one preferred embodiment, the terminal communication apparatus 200 should utilize and is connected to the wireless carrier communication network 310 for the transmission of all live audio-visual content. However, similar to the portable communication apparatus 100, if the terminal communication apparatus 200 is unable to connect to the wireless carrier communication network 310, the system and terminal communication apparatus 200 is configured to connect to the wired internet communications service provider network 410 to receive (and transmit back) the live audio-visual content signal to and from the portable terminal communication apparatus 200 and camera crew at the remote location.

As will be described in greater detail below, the portable communication apparatus 100 can be mounted within a rugged, outdoor ready case or housing that may also be mounted in a ‘backpack’ configuration. The portable communication apparatus 100 can receive any analog video or audio source (output of a camera 302, 402, video switcher, DVD, etc) through video and audio input connectors. In general, the video and audio from these connectors is converted to a digital signal and transmitted over the wireless carrier communication network 310 and/or wired internet communications service provider network 410 to the terminal communication apparatus 200. In addition, as will be described in greater detail below, the system allows for a return video and audio path for talent cues, air verification, etc. The portable communication apparatus 100 includes a video connector and audio connectors for the return output signal. The portable communication apparatus 100 can further include a headphone level output to monitor the return audio channel for talent cues, etc. As described, the portable communication apparatus 100 can include a monitor 106 which allows the user to feed any one of at least three sources: 1) the video input feeding the portable communication apparatus 100, 2) the return video output received from the terminal communication apparatus 200, or 3) a static logo that can display the station's logo, advertisements, etc. The portable communication apparatus 100 can further include and be powered by a standard portable Anton Bauer battery, as shown through the connections within FIG. 1, for powering at least the input/output switch 102, the audio matching converter 110, the codec 106, the wireless modem 130, and the router 122. The portable communication apparatus 100 can alternatively be powered through a 4 pin XLR power connector for external +12VDC power.

In one embodiment, the terminal communication apparatus 200 is an indoor, 2 RU (rack-mount unit) which includes a video connector and two audio output connectors for outputting the received from the portable communication apparatus 100. The terminal communication apparatus 200 also includes video and two audio input connectors used for transmitting the live audio-visual content from the terminal communication apparatus 200 to the portable communication apparatus 100. The terminal communication apparatus 200 can be powered by standard 120V AC connections, as shown through the connections within FIG. 1.

In one embodiment, the input/output switch 102 of the portable communication apparatus 100 receives a live video content signal through the VIDEO IN connection shown in FIG. 1. The audio matching converter 110 receives a live audio content signal through the AUDIO IN connectors, and unbalances the live audio content signal. As mentioned, the live audio content signal and the live video content signal can be received from the camera 302, 402 capturing live audio-visual content. As shown in FIG. 1, the codec 116 is connected to and is in communication with the input/output switch 102 and receives the live video content signal that is transmitted from the input/output switch 102. The codec 116 is also connected to and is in communication with the audio matching converter 110 and receives the unbalanced live audio content signal from the audio matching converter 110. The codec 106 encodes the live visual content signal and the unbalanced live audio content signal into a UDP streaming content signal for use in transmitting the UDP streaming content signal to the terminal communication apparatus 200. In one embodiment, the codec 106 encodes the live visual content signal and the unbalanced live audio content signal into an H.264 formatted UDP streaming content signal. The router 122 is connected to and is in communication with the codec 116 and the wireless modem 130, and receives the UDP streaming content from the codec 116 and routes the UDP streaming content to the wireless modem 130. The wireless modem 130 is a 4G or higher wireless modem that receives the UDP streaming content and transmits the UDP streaming content to the remote terminal communication apparatus 200 at a second remote location (broadcast station) over a 4G or higher wireless carrier communication network 310.

In one embodiment, the wireless modem 130 receives a broadcast signal back from the terminal communication apparatus 20 at the broadcast station at the second remote location, over the wireless carrier communication network 310. The wireless modem 130 transmits the broadcast signal to the router 122, which in turn routes the broadcast signal to the codec 116. The codec 116 receives the broadcast signal in UDP streaming format and decodes the broadcast signal into a live broadcast video content signal. The codec 116 further decodes the broadcast signal into a live unbalanced broadcast audio content signal. The codec 116 transmits the live broadcast video content signal to the input/output switch 102 and transmits the live unbalanced broadcast audio content signal to the audio matching converter 110. The audio matching converter 110 converts the live unbalanced broadcast audio content signal received from the codec 116 into a live balanced broadcast audio content signal for communicating the balanced broadcast audio content signal to an audio generation device through AUDIO OUT connectors. The unbalanced left and right channel audio output shown in FIG. 1 can be fed to a headphone amplifier circuit then to a ¼″ stereo connector mounted to the housing, described below. A 10 k adjustable potentiometer can be provided to adjust volume level to a headphone circuit.

The live broadcast video content signal received by the input/output switch 102 can then be communicated through the VIDEO OUT connector, and or to the monitor in communication with the input/output switch 102. Specifically, the input/output switch 102 receives the live broadcast video content signal from the codec 116 and communicates the live broadcast video content signal to the monitor 106 in communication with the input/output switch 102 for viewing the live audio-visual content as broadcasted by the broadcast station, through the monitor. This allows for viewing on the monitor of the actual view of what is or will be broadcasted by the broadcast station at the second remote location through the terminal communication apparatus 200. The broadcast station broadcasts the live audio-visual content through a broadcast signal, which can be in the form of at least of a radio frequency transmission signal, a cable transmission signal, and/or an internet protocol transmission signal, the forms of which are understood by one of skill in the art. The portable communication apparatus 100 can also be configured through the use of a switch (labeled SOURCE in FIG. 1) to receiving a live video signal from the input/output switch 102 for viewing the live audio-visual content prior to transmission of the live audio-visual content through the wireless modem 130.

The portable communication apparatus 100 also can include a logo generator 140 in communication with the input/output switch 102. The logo generator 140 generates a logo signal and transmits the logo signal to the input/output switch 102. The input/output switch 102 transmits the logo signal alone or together with the live video content signal to the codec 116. The logo generator 140 further includes an IP input connector, which allows the logo generator to receive logo graphics over the Internet and/or from a local computer connected to the portable communication apparatus 100. The logo generator 140 further includes memory for storing the logo graphics. The logo graphics can then be used by the logo generator 140 to generate the logo signal.

In one embodiment of the portable communication apparatus 100, the codecs 116, 216 can be configured to adjust the transmission rate of the UDP streaming content over the wireless carrier communication network 310, as set forth above herein. As such the codecs 116, 216 can be configured to determine or set a transmission rate for encoding the live visual content signal and the unbalanced live audio content signal into the UDP streaming content signal. On the portable communication apparatus 100 side, the UDP streaming content signal is then transmitted to the remote terminal device 200 at the second remote location over the 4G or higher network 310. The codecs 116, 216 can be configured to determine the transmission rate based on the quality of transmission of the UDP streaming content that is taking place. Specifically, the codecs 116, 216 can determines the quality of the transmission of the UDP streaming content by determining a transmission error rate of the current UDP streaming content, as described herein. In one embodiment, the codecs 116, 216 can then determine or set the transmission rate by comparing the transmission error rate to a predetermined error threshold. In one specific embodiment, if the transmission error rate is greater than ten (10) percent, the codecs 116, 216 can be configured, or programmed using program code, to reduce the transmission rate of the UDP streaming content by a specific bit rate or by a specific percentage. The codecs 116, 216 can be configured, or programmed using program code, to alternatively utilize a next predetermined transmission rate in a set of transmission rates stored in memory of the codecs 116, 216. Thus, in one embodiment, the codecs 116, 216 can be configured to determine or set a higher transmission rate if the transmission error rate is less than the predetermined error threshold and a lower transmission rate if the transmission error rate is greater than the predetermined error threshold. Likewise, in another embodiment, the codecs 116, 216 can determine or set the transmission rate by determining a transmission error rate and looking up a respective transmission rate from a transmission rate table stored within the memory.

As set forth briefly herein above, the system of the present invention can be configured so that the wireless communication network 301 sets aside a priority bandwidth for the transmission of the live audio-visual content for news reporting. There are at least a few ways in which this can be accomplished. In one embodiment, the codec 116 can be configured to encode priority meta data information representing that the UDP streaming content signal is live audio-visual content for communication to a broadcast carrier. The portable communication apparatus 100 transmits the priority meta data as a part of or in association with the UDP steaming content to the wireless communication network 301. As set forth herein, the wireless communication network 301 can include a first communication apparatus that is configured to receive the priority meta data and determine, such as through the use of program code, that the source of the UDP streaming is a priority source based on the priority meta data. The first communication apparatus of the wireless communication network 301 can further be configured to transmit the UDP streaming content signal over a priority bandwidth of the 4G or higher network if the first communication apparatus determines that the source of the UDP streaming content signal is a priority source.

As set forth herein above, the system includes the terminal communication apparatus 200 for facilitating transmission of live audio-visual content between the first location and the second remote location. The carrier receiving unit 230, such as a 4G or higher wireless modem 230, of terminal communication apparatus 200, receives the UDP streaming content, representing live audio-visual content, from the remote portable communication apparatus 100 located at the first remote location. The UDP streaming content will be received over a 4G or higher network. The router 222 is connected to and is in communication with the carrier receiving unit 230 and with the codec 216, and receives the UDP streaming content from the carrier receiving unit 230 and routes the UDP streaming content to the codec 216. The codec 216 is connected to and is in communication with the carrier receiving unit 230, receives the UDP streaming content and decodes the UDP streaming content signal into a broadcast video content signal, and also decodes the UDP streaming content into an unbalanced broadcast audio content signal. The audio matching converter 210 is connected to and is in communication with the codec 216, receives the unbalanced broadcast audio content signal, and balances the unbalanced broadcast audio content signal into a balanced broadcast audio content signal. The input/output switch 202 receives the broadcast video content signal and transmits the broadcast video content signal to a broadcast signal generation device. The audio matching converter 210 transmits the balanced broadcast audio content signal to the broadcast signal generation device for broadcasting audio-visual content to content receiver and display device 330. A monitor 206 is connected to and is in communication with the input/output switch 202 for receiving the broadcasted video signal from the input/output switch 202 for viewing the broadcasted audio-visual content as it is being broadcasted by the broadcast station at the second location. Other selections can be made for viewing on the monitor 206.

For the return audio-visual content feed to portable communication apparatus 100, the input/output switch 202 receives the broadcast (including pre-broadcast) video signal from the VIDEO IN connector and transmits the broadcast video signal to the codec 216. The input/output switch 202 can also receive a signal from an aux input video connector located on the rear of the terminal communication apparatus 200, and which also feeds the input of an input select switch. The broadcast audio signal is received by the audio matching converter 210 from the AUDIO IN connectors. The audio matching converter 210 unbalances the broadcast audio signal into unbalanced broadcast audio signal. The unbalanced audio output can be fed to a headphone amplifier circuit then to a ¼″ stereo connector mounted to the front of the unit. A 10 k adjustable potentiometer provides volume level adjustment to the headphone circuit. The codec 216 is connected to and is in communication with the audio matching converter 210 and the input/output switch 202, for receiving the unbalanced broadcast audio signal and the broadcast video signal, and for encoding the unbalanced broadcast audio signal and the broadcast video signal into a broadcast signal in UDP streaming format, representing broadcasted video content. The codec 216 is configured to encode the unbalanced broadcast audio signal and the broadcast video signal into the broadcast signal in UDP streaming format, in a resolution which is less than the resolution of the UDP streaming content, representing live audio-visual content by the carrier receiving unit from the remote portable communication apparatus at the first remote location. Using a lower resolution allows the return feed to be sent by the terminal communication apparatus 200 and received by the portable communication apparatus 100 at a faster transmission rate, with lower transmission errors, and with less delay when viewed on the monitor 106 of the portable communication apparatus 100.

Setting up and configuring the portable communication apparatus 100 and terminal communication apparatus 200, and the various components therein, including the codec (encoder/decoder), and wireless carrier router, can be accomplished via a computer 335 (directly or over the Internet). RJ-45 Ethernet connectors can be mounted to the front and the rear of the apparatuses 100, 200 for configuration as well as for connecting the portable communication apparatus 100 and terminal communication apparatus 200 via the Internet, if the wireless carrier is not available. The wireless carrier router 222 automatically hunts for the wireless carrier's network 301. Should the network be unavailable, the router 222 can be configured via the web interface to use a wired Internet interface that can be plugged into the front or rear Ethernet ports. This mode of operation can be disabled to prevent switching to the public Internet or left enabled for backup purposes. A POE Ethernet port can also be located on the rear of the terminal communication apparatus 200 to connect to the integrated wireless carrier router/antenna 222 that is mounted outdoors and fine tuned for maximum signal from the wireless carrier's system.

FIG. 2 is a graphical representation of an exemplary system for facilitating transmission of live audio-visual content between a first location and a second remote location. As shown in FIG. 2, a communications network 310 communicatively connects the portable communications apparatus 100 with the remote communication apparatus or terminal device 200. As described, the portable communications apparatus 100 transmits a signal, which may be a wirelessly-transmitted UDP signal, to the communications network 310. The signal sent by the portable communication apparatus 100 is received by a base station of the communications network 315, such as a cellular tower or the like. The communications network 310 preferably utilizes fourth generation protocol (4G) wireless communications, such as the Sprint™ 4G network, or other comparable or higher performance. Preferably, communications network 310 is capable of delivering data rates of at least 300-2300 kilobytes per second. Once the signal is received by the communications network 310, the signal is routed through the communications network and transmitted to the remote terminal communication apparatus 200.

The remote terminal communication apparatus 200 may be in wired connectivity, such as through a LAN or WAN, with the communications network, in which case the signal is transmitted from the communications network to the remote terminal communication apparatus 200 via the wired connection. Alternatively, the connection between the remote terminal communication apparatus 200 and the communications network may be a wireless one, such that a wireless signal is sent from the communications network to a carrier receiving unit, such as a 4G modem, communicatively connected to the remote terminal communication apparatus 200.

The communications network 310 also provides for communication from the portable communications apparatus 100 to the remote terminal communication apparatus 200 such that signals sent from the remote terminal communication apparatus 200 to the communications network are transmitted by the communications network to the portable communication apparatus 100. Thus, the communications network provides bidirectional communication between the portable communication apparatus 100 and the remote terminal communication apparatus 200.

From the remote terminal communication apparatus 200, the content received from the portable communications apparatus 100 may be broadcast via a broadcast signal generation device to content receiver and display device 330. Content receiver and display devices may be television sets, computers, hand held devices and/or any other devices capable of receiving audio-visual content, which are capable of receiving broadcast audio-visual content via a wide variety of means that are known in the art.

FIG. 3 depicts an alternative mode of operation for the system in which the portable communication apparatus 100 is connected with the remote terminal communication apparatus 200 via a wired internet communications network 410. In this mode of operation, the portable communication apparatus 100 may be communicatively connected to the Internet 410, for example via a WAN or LAN, which is used to transmit signals between the remote terminal communication apparatus 200 and the portable communications apparatus 100.

Various portions of the system may utilize a client computer or other computer. For example, a computer 335, shown in FIGS. 2 and 3, can be used to interface with the codecs 116, 216, router 122, 222, and/or logo generator 140, of the portable and/or terminal communication apparatuses 100, 200. This may include and/or provide access to a set of interface screens and functionality for performing various set up and configuration functions. The computers 335 and other computers that may be used within the system may include a memory element. The memory element may include a computer readable medium for implementing such interface screens. Such computers can run an interface program, such as an Internet browser application, for connecting to the Internet, which can be server-based. Firewall and other security systems and applications (not shown) may be used to prevent and deter unauthorized access such as is known in the computer networking art.

The computers 335 and other functional features of the system may be implemented in software, firmware, hardware, or any combination thereof. For example, the codec can be implemented in software, as an executable program, and is executed by one or more special or general purpose digital computer(s), such as a programmable logic controller (PLC).

In terms of hardware architecture, the computers and other functional components of the system can include a processor, memory, and one or more input and/or output (I/O) devices (or peripherals) that are communicatively coupled to one another, such as through one or more buses or other wired or wireless connections, as is known in the art. Controllers, buffers (caches), drivers, repeaters, and receivers, may also be used to enable communications.

Various processors will be used within the system. A processor is a hardware device for executing software, particularly software stored in memory. The processor can be any custom made or commercially available processor, a central processing unit (CPU), an auxiliary processor among several processors, a semiconductor based microprocessor (in the form of a microchip or chip set), or generally any device for executing software instructions. Examples of some commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc., or a 68xxx series microprocessor from Motorola Corporation. The processors may also represent a distributed processing architecture such as, but not limited to, SQL, Smalltalk, APL, KLisp, Snobol, Developer 200, MUMPS/Magic.

Various memory will also be used within the system. The memory can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory may incorporate electronic, magnetic, optical, and/or other types of storage media. The memory can have a distributed architecture where various components are situated remote from one another, but are still accessed by processors.

Various software or program code will also be used within this system. The software in memory may include one or more separate programs. The separate programs comprise ordered listings of executable instructions for implementing logical functions. The software in memory will also typically include a suitable operating system (O/S). A non-exhaustive list of examples of suitable commercially available operating systems is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). The operating system essentially controls the execution of other computer programs, such as the commodity resource private trading market facilitator system and provides scheduling, input-output control, file and data management, memory management, and communication control and related services.

Portions of the system may be a source program, executable program (object code), script, or any other entity comprising a set of instructions to be performed. When a “source” program, the program needs to be translated via a compiler, assembler, interpreter, or the like, which may or may not be included within the memory, so as to operate properly in connection with the O/S. Furthermore, portions of the system can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, .Net, HTML, and Ada.

The system will further utilize various I/O devices. The I/O devices may include input devices, for example but not limited to, input modules for PLCs, a keyboard, mouse, scanner, microphone, touch screens, and interfaces for various functional features. Furthermore, the I/O devices may also include output devices, for example but not limited to, output modules for PLCs, a printer, bar code printers, displays, etc. Finally, the I/O devices 306 may further comprise devices that communicate with both inputs and outputs, including, but not limited to, a modulator/demodulator (modem; for accessing another device, system, or network), a radio frequency (RF) or other transceiver, a telephonic interface, a bridge, and a router.

If the computers are PCs, workstations, PDAs, or the like, the software in the memory may further include a basic input output system (BIOS). The BIOS is a set of essential software routines that initialize and test hardware at startup, start the O/S, and support the transfer of data among the hardware devices. The BIOS is stored in ROM so that the BIOS can be executed when the computer is activated.

When any of the computers are in operation, the processors therein are configured to execute software stored within the memory, to communicate data to and from the memory, and to generally control operations of the computer pursuant to the software.

When the various portions of the system are implemented in software, it should be noted that such portions of the system can be stored on any computer readable medium for use by or in connection with any computer related system or method. Such portions of the system can be embodied in any type of computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” may be any means that can store, communicate, propagate, or transport the program for use by or in connection with the instruction execution system, apparatus, or device. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

In another embodiment, where various portions of the system are implemented in hardware, such portions may also be implemented with any of the following technologies, or a combination thereof, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In one embodiment shown in FIGS. 2 and 3, the system includes a first communication apparatus within the communication network 301, 410 for receiving the UDP streaming content signal from the portable communication apparatus 100. The system also includes a second communication apparatus within the communication network 301, 410 for transmitting the UDP streaming content signal to the terminal communication apparatus 200 received from the first communication apparatus. The first communication apparatus can be configured to determine an IP address of the source of the UDP streaming content signal based on meta data within the UDP streaming content signal. In addition, the first communication apparatus can be configured to determine whether the source of the UDP streaming content signal is a priority source based on the IP address of the source. Further, the first communication apparatus can be configured to transmit the UDP streaming content signal over a priority bandwidth of the 4G or higher network of the communication network 301, 410 if the first communication apparatus determines that the source of the UDP streaming content signal is a priority source.

In a further embodiment, as set forth herein, a modem is used to manage the connection to the network. As such, the public IP address may change. Furthermore, the network topology could be complex with several decoders (or even encoders) sharing the same public IP addresses. Thus, if an address translation is required, it can be performed by a NAT/router. As a consequence, the communication between the encoder and the decoder rely not only on IP addresses but also on IP ports. Specifically, each encoder can be assigned a fixed IP address and a reception port for messages from the decoder, and each decoder can be assigned a fixed IP address and a reception port for messages from the encoder. As such, configuration of the encoders and decoders will preferably include at least: for encoder IP configuration a) an encoder private IP address, b) a decoder public IP address, and c) a UDP port for “encoder to decoder” messages (E2D); for decoder IP configuration a) a decoder private IP address and b) a UDP port for “decoder to encoder” messages (D2E). If there are several encoders or decoders sharing the same public IP address, paquet switching can be performed using dedicated ports, in which a NAT configuration is used.

In one embodiment, the encoder and decoder addresses should be synchronized. In one specific embodiment, two UDP periodical messages (every 1 s) are exchanged between the encoder and the decoder to manage their communication:
A) E2D message=Encoder→Decoder: D2E reception port, streaming status (Sending/Stopped), maximum available bit rate, minimum available bit rate, CRC-32
B) D2E message=Decoder→Encoder: encoder IP address, encoding bit rate, CRC-32

The encoder can be configured to send E2D messages every second regardless of the decoder presence. The decoder answers at the reception of each E2D by sending a D2E message to the encoder. These 2 messages can be used to solve connection/de-connection issues. In particular, the following connection/deconnection issues can be determined using the following messages and logic:

1) How the decoder knows that the connection is lost: no E2D message received from the encoder for 5 s.

2) How the encoder knows that the connection is lost: no D2E message received from the decoder for 5 s.

3) How the decoder knows that the encoder was assigned a new IP address: the decoder has received a E2D message from a new IP address.

4) How the encoder knows that it was assigned a new IP address: the encoder was informed by the decoder in the last D2E message.

5) What shall the encoder do when the connection is lost: a) stop streaming (i.e. reset the streamer), streaming status in E2D messages will be set to “Stopped”; b) wait for the next D2E message; c) wait for standard RTP/RTSP communication initiated by the decoder.

6) What shall the encoder do when its IP address has changed: a) stop streaming (i.e. reset the streamer); streaming status in E2D messages will be set to “Stopped”; b) wait for the next D2E message; c) wait for standard RTP/RTSP communication initiated by the decoder.

7) What shall the decoder do when the connection is lost: a) stop receiving (i.e. reset the receiver); b) wait for the next E2D message with a streaming status set to “Stopped”; c) initiate standard RTP/RTSP communication.

8) What shall the decoder do when the encoder IP address has changed: a) stop receiving (i.e. reset the receiver); b) wait for the next E2D message with a streaming status set to “Stopped”; c) initiate standard RTP/RTSP communication.

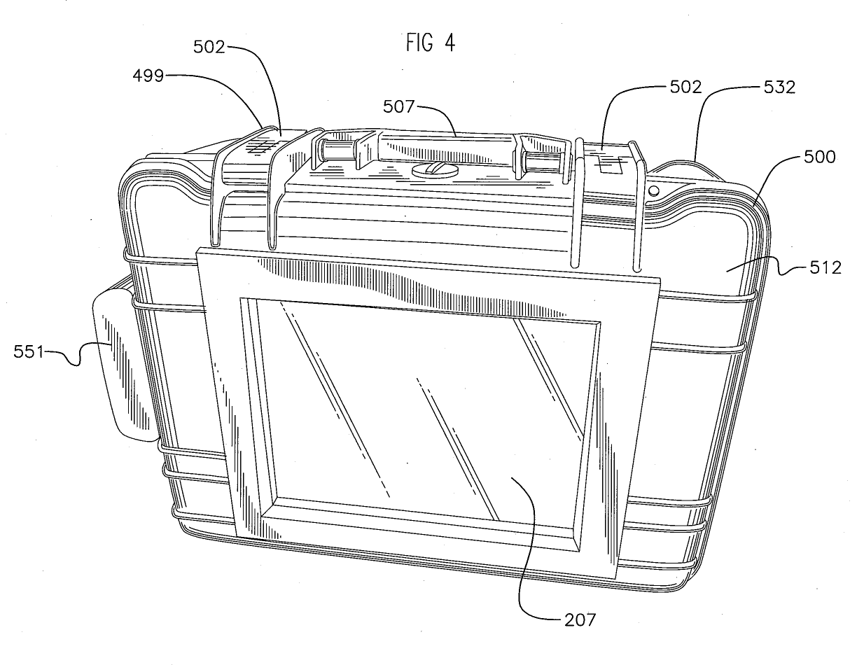

FIGS. 4-8 show an embodiment of a portable communication apparatus 499. As shown in FIGS. 4-8, the portable communications apparatus 499 has a housing 500 containing various hardware and electrical components of the portable communications apparatus 499. The housing 500 may be made of a durable, impact-resistant plastic or plastic composite and is preferably also warp resistant.

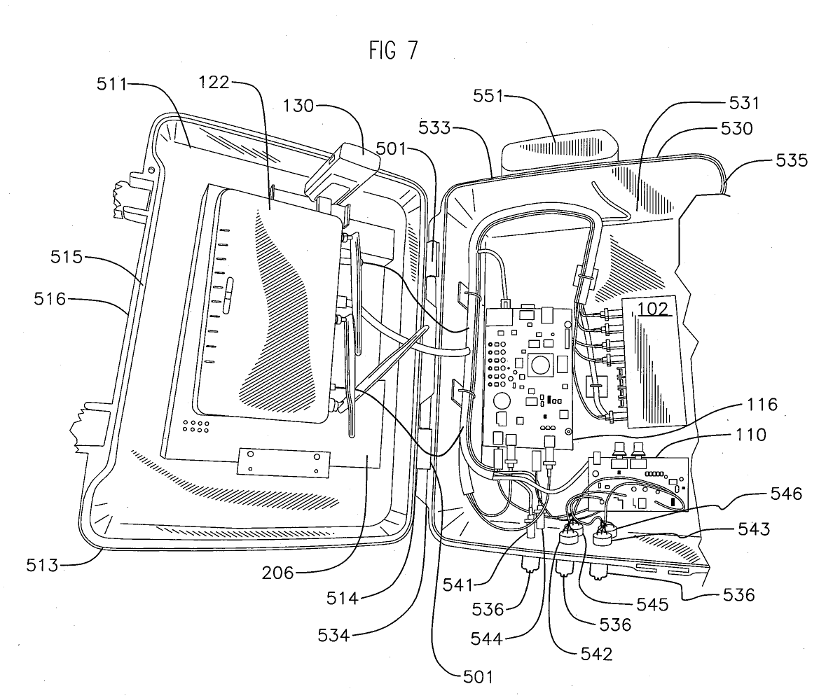

The housing 500 forms a water-resistant enclosure to protect the hardware and electrical components contained within the housing from exposure to rain or other moisture. As shown in the embodiment shown in FIG. 7 the housing is comprised of a first housing portion 510 and a second housing portion 530. The first housing portion has a first housing interior 511, a first housing portion exterior 512 and a first housing portion edge 513. The first housing portion edge has a surface forming a plane and forms a perimeter of the first housing portion. The second housing portion 530 has a second housing portion interior 531, a second housing portion exterior 532 and a second housing portion edge 533. The second housing portion edge has a surface forming a plane and forms a perimeter of the second housing portion. A first side of the first housing portion 514 and a first side of the second housing portion 534 are joined by at least one hinge 501. Portions of the hinges 501 may be formed by the first and second housing portions.

On a second side of the first housing portion 515 and a second side of the second housing portion 535, located opposite the hinges 501, the first and second housing portions are releasably joined via first and second latches 502. When the latches 502 are closed, the first housing portion 510 and the second housing portion 530 form a housing interior 503 within which the various hardware and electrical components are disposed. When the housing 500 is in the closed position, as shown in FIG. 4, the first housing portion edge 513 and the second housing portion edge 533 are located adjacent one another. A gasket 515 or other similar seal is located in a channel 516 formed in the edge 513 of the first housing portion 510. The second housing portion edge 533 also has a channel 536 formed therein and configured to receive a portion of the seal 515 when the two housing portions are closed. Gasket 515 is preferably sized to provide for a slight amount of compression of the gasket when the housing portions 510 and 530 are closed and latched by the latches 502, whereby gasket 515 creates a water resistant barrier preventing water from entering the housing interior 503. Thus, the closure of the two housing portions forms a housing interior 503 disposed in which are video switch 102, audio matching convertor 110, codec 116, and router 122. Modem 130 may also be disposed within the housing interior.

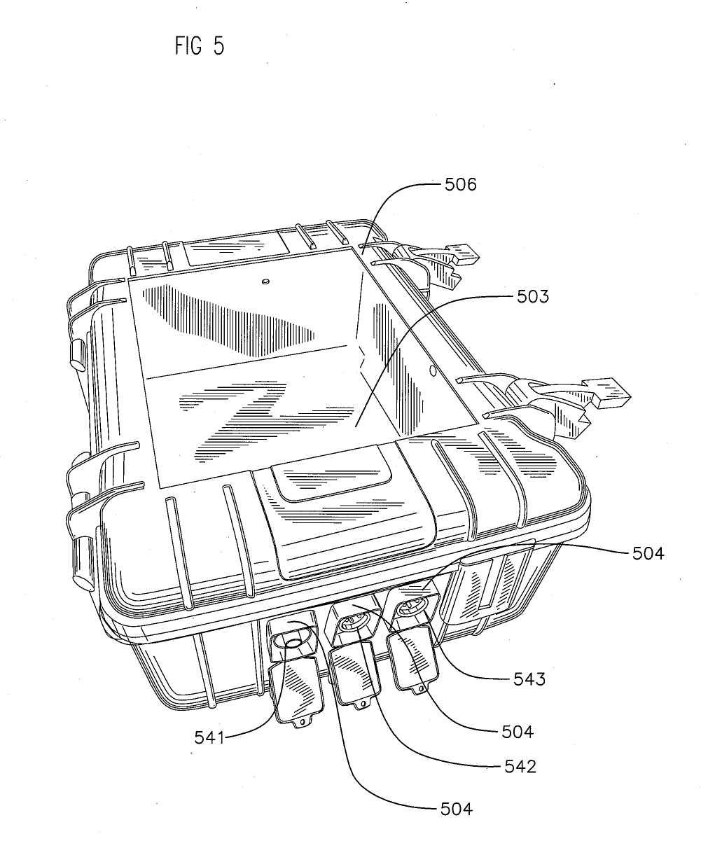

A plurality of input and output connectors are disposed on and through the housing providing for connection of the portable communications apparatus to various input, output and other devices. As shown in FIG. 5 a video input connector 541, shown as a Bayonet Neill-Concelman (BNC) connector, is disposed on the housing for connection to an external video source, such as a camera. Disposed on the housing adjacent the video input connector are two audio input connectors 542, 543, which are shown as XLR connectors, for connection to an external audio source. For example, the audio input source may be a microphone. As shown in FIG. 7, a video output connector 544, shown as a BNC connector, and two audio output connectors 545, 546 shown as XLR connectors, are also disposed on the housing for providing for connection to video and audio receiving devices, respectively. Video output connector 544 and audio output connectors 545 and 546 may be located on the housing proximite to the video input connector 541 and audio input connectors 542 and 543.

As shown in FIG. 5, the video and audio input and output connectors 541-546 may each be disposed within a weatherproofed outlet box 504, each of which extends outward approximately perpendicular to the exterior of either the first or second housing portion. The weatherproofed outlet box may have a hinged cover 505. The hinged cover may be attached to the outlet box by an outlet box hinge on one end of the outlet box 504 and friction-fit mechanism on an opposite end. Thus, the outlet boxes 504 may be closed to form an enclosure around the video and audio input and output connectors 541-546 to protect those connectors when they are not in use.

A third audio output connector (not shown) may be a one-quarter inch stereo connector, and may be disposed on the housing to provide audio output to a headphone. The housing 500 may also have disposed thereon an audio output level control (not shown) for adjusting the volume level of the output to the third audio output connector, which may provide output to the headphone. The audio output level control may be a potentiometer or any other audio level control known in the art.

As shown in FIGS. 4-5, housing 500 may have an opening 506 for receiving the display of a video monitor 206, which is also disposed on the housing such that the display of the video monitor 207 is viewable from the exterior of the housing. As shown in FIG. 7, the portions of the video monitor other than the video display 207 are preferably housed within the interior of the housing. A gasket or seal (not shown) may be located between the housing 500 and the video monitor 206 to ensure that interface between the housing and the monitor is water resistant. The video monitor 206 may be a NEMA type 4 rated 10.4 inch LCD monitor to provide for video display. A video display switch (not shown) may be a three-button membrane switch which is disposed on the housing and accessible with the housing closed for selecting between video sources for display on monitor 206. As discussed in additional detail elsewhere, the video display switch permits a user to select between video sources including video received from the camera, video received from the remote terminal device, or video received from the logo generator.

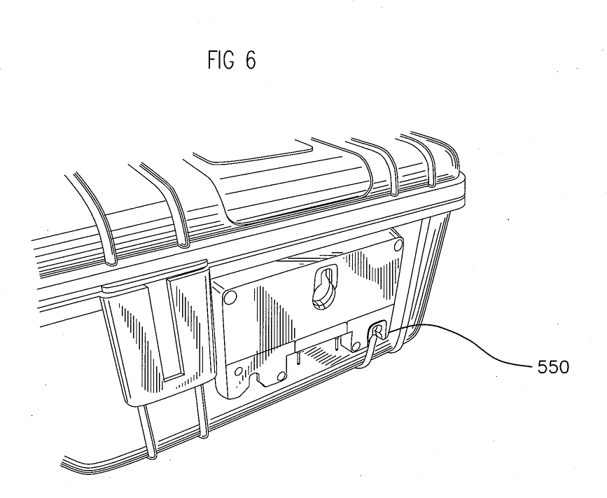

Also disposed on housing 500 are one or more connectors 550 for connecting the portable communications apparatus 499 to a power source to provide power to the components of the portable communications apparatus. As shown in FIG. 6, housing 500 provides a direct current (DC) connector 550 for attachment of a direct current power source, shown in FIGS. 4 and 7 as battery 551, which may, in a preferred embodiment be an Anton-Bauer™ battery. Such batteries may be Nickel-Cadmium, Nickle-Metal-Hydride, Lithium-Ion or any other suitable cell chemistry as desired. As shown in FIGS. 6 and 7, battery connector 550 may also provide for physical attachment and support of battery 551 to securely attach battery 551 to the battery connector 550 disposed onto the housing 500. Conventional means for attaching and securing the battery may be used depending upon the configuration of the battery. Alternatively, the DC connector may provide for attachment via a power cord connected to a battery pack that is not secured to the housing, for example a battery pack that may be worn as a battery belt by a user.

Housing 500 may also provide a connector for receiving a wired 12-volt DC power source, such as a 4 pin XLR connector (not shown). A power source switch (not shown) may also be disposed on the housing for switching between the wired power source and the battery power source. Preferably a connector for receiving a wired 12-volt DC power source is housed in a weatherproof outlet box similar to outlet boxes 504, shown for use in connection with the video and audio input connectors. A TNC external antenna connector (not shown) for attachment of an antenna, such as a 6″ whip antenna, may also be disposed on the housing for providing transmission and receipt of wireless signals via the wireless modem 130.

Each of the connectors disposed on the housing and providing access to and/or communication with components housed on the housing interior 503 is preferably disposed through openings in the housing 500 so that the interface of each of the so-disposed components and the housing 500 forms a water-resistant seal to prevent moisture from entering the interior of the housing 503. As discussed with respect to the video monitor, such water resistance may be achieved through the use of a gasket or other seal positioned between the component and the housing or other secure, water-resistant attachment means.

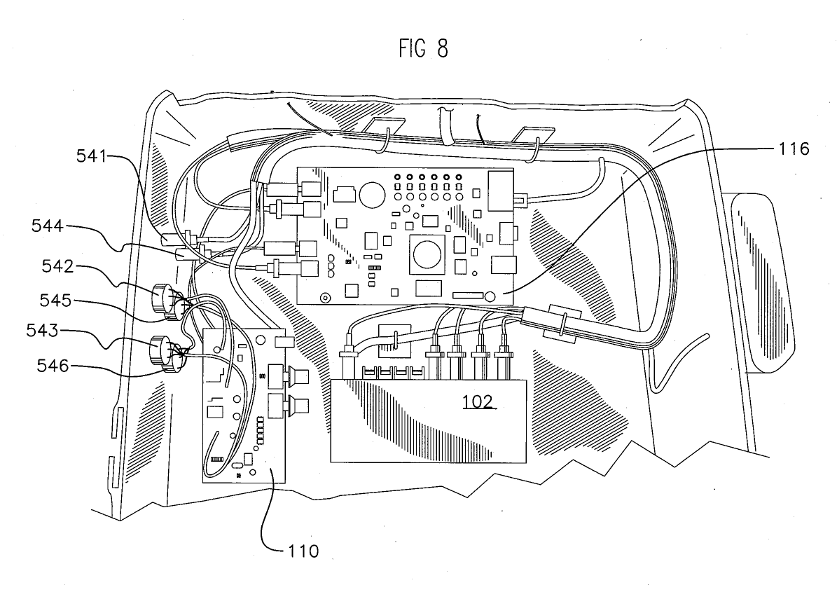

FIGS. 7-8 provide additional details showing the various hardware and electrical components disposed in the interior of the housing. As shown in FIG. 7, router 122 is disposed in the housing interior 503. Router 122 may be disposed adjacent video monitor 206. Video monitor 206 is communicatively connected with video switch 102 and in electrical connection with battery connector 550. Modem 130 is communicatively connected with router 122. Router 122 is also communicatively connected to codec 116 and in electrical connection to battery connector 550.

As shown in FIG. 8, video switch 102 is mounted in the housing interior 503 and communicatively connected to video input connector 541, video output connector 544, video monitor 106, codec 116 and in electrical connection with battery connector 550. Audio matching convertor 110 is shown mounted adjacent video switch 102 and audio input and output ports 542, 543, 545 and 546. Audio matching convertor 110 is communicatively connected to audio input and output ports 542, 543, 545 and 546, and codec 116 and in electrical connection with battery connector 550. Codec 116 is shown in FIG. 8 mounted on the housing interior 503 proximate to video switch 102. Codec 116 is communicatively connected with video switch 102, audio matching convertor 110 and router 122 and in electrical connection with battery connector 550.

Router 122 may also contain one or more computer network communications ports (not shown in FIGS. 4-8) such as an RJ 45 Ethernet jack to provide for connection of the portable communications apparatus to a computer network such as a WAN or LAN. Alternatively, one or more such network communications ports may be disposed on the exterior of housing and communicatively connected to router 122 to enable external connection of the apparatus to a computer network via a WAN or LAN without the need to open the housing.

The locations of the components within the housing 500, as shown in FIGS. 4-8 are meant to show one exemplary embodiment of a possible configuration of the components in the housing interior 503, but are not to be construed as limiting.

As shown in FIG. 4, housing 500 may also have a handle 507 to permit a user to conveniently carry the portable communications apparatus.

In an alternative embodiment, the apparatus may have at least one strap attached to the housing to enable a user to wear the apparatus and support the weight of the apparatus with the user's body while leaving the user's hands free to operate a camera or microphone or perform other tasks. Such a configuration permits the user to easily transport the portable communications device simply by walking. Such a configuration also permits the user to transport the portable communications device with minimal effort and allows the user to navigate through crowded areas or areas in which a device could not easily transported separate from the user.

In another embodiment, the housing 500 has at least a first attachment feature that provides for attachment of a first strap at a first location on the first strap. Housing 500 may have a second attachment feature which provides attachment of the strap to the housing 500 at a second attachment location on the strap. A single strap may be attached around the user's waist as a ‘fanny-pack’ such that the portable communications device is worn near the user's waist, and may be worn at the front, side or back of the user. Alternatively, a single strap may be configured to be worn over one shoulder of the user similar to a messenger bag.

The portable communications device may also have a second strap attached to a third attachment feature on the housing and, optionally, may be attached at a fourth attachment feature on the housing 500. The first and second straps may be worn over the user's shoulders, as a backpack, so that the portable communications device is worn on the user's back. Alternatively, the first and second straps may be configured to permit the portable communications device to be worn on the user's stomach or chest, as a frontpack.

The first and second straps also preferably have one or more buckles or latches to provide for connection of portions of the straps. The straps may also have one or more adjustment features to facilitate the wearing of and removal of the portable communications apparatus by the user and to provide for adjustment of the size of the straps to accommodate users of different sizes. Additional straps, such as a third strap, which could connect the first and second straps at a position on the user's chest (in the backpack configuration) or across the user's upper back (in the front pack configuration) may also be used to provide additional fit and support. Similarly, a third strap may be added to the backpack or frontpack embodiments, in which the third strap could be worn around the user's waist to provide additional fit and support.

The housing may further be adapted to facilitate wearing of the apparatus through the contouring of the housing portions or the addition of padding to the housing.

In yet an alternative embodiment that permits a user to wear the apparatus, a fabric pouch may receive the apparatus. The fabric pouch containing the apparatus may have openings corresponding to and aligned with the various components located on the housing exterior to permit access to the components, for example, the fabric pouch may have an opening that permits access to the audio and video output and input ports and/or an opening that permits viewing of the video monitor. The fabric pouch may further have one or more straps attached to the pouch which can be worn as shoulder straps by a user, to allow the user to wear the portable communications apparatus as a frontpack or backpack.

Any process descriptions or blocks in the figures should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

What is claimed is:

1. A portable communication apparatus for facilitating transmission of live audio-visual content between a first location and a second remote location, comprising:
an input/output switch for receiving a live video content signal;
an audio matching converter for receiving a live audio content signal and for unbalancing the live audio content signal;
a codec in communication with the input/output switch for receiving the live video content signal transmitted from the input/output switch and for receiving the unbalanced live audio content signal, and for encoding the live visual content signal and the unbalanced live audio content signal into a UDP streaming content signal; and,
a 4G or higher wireless modem in communication with the codec for receiving the UDP streaming content and for transmitting the UDP streaming content to a remote terminal device at a second remote location over a 4G or higher network.

2. The portable communication apparatus of claim 1, further comprising:
a router in communication with the codec and the wireless modem for receiving the UDP streaming content and for routing the UDP streaming content to the wireless modem.

3. The portable communication apparatus of claim 1, further comprising:
a portable battery supply in communication with and for powering the input/output switch, the audio matching converter, the codec and the wireless modem.

4. The portable communication apparatus of claim 1 wherein the live audio content signal and the live video content signal are received from a camera capturing live audio-visual content.

5. The portable communication apparatus of claim 4, further comprising:
a monitor in communication with the input/output switch for receiving a live video signal from the input/output switch for viewing the live audio-visual content prior to transmission of the live audio-visual content through the wireless modem.

6. The portable communication apparatus of claim 4 wherein the wireless modem transmits the UDP streaming content of the live audio-visual content to a broadcast station over a 4G or higher wireless network, and wherein the wireless modem receives a broadcast signal from the broadcast station.

7. The portable communication apparatus of claim 6 wherein the codec receives the broadcast signal in UDP streaming format and decodes the broadcast signal into a live broadcast video content signal.

8. The portable communication apparatus of claim 7 wherein the input/output switch receives the live broadcast video content signal from the codec for communicating the live broadcast video content signal to a monitor in communication with the input/output switch for viewing the live audio-visual content as broadcasted by the broadcast station, through the monitor.

9. The portable communication apparatus of claim 7 wherein the codec further decodes the broadcast signal into a live unbalanced broadcast audio content signal, wherein the audio matching converter converts the live unbalanced broadcast audio content signal received from the codec into a live balanced broadcast audio content signal, and further wherein the input/output switch receives the balanced broadcast audio content signal for communicating the balanced broadcast audio content signal to an audio generation device.

10. The portable communication apparatus of claim 9 wherein the audio generation device are headphones in communication with the input/output switch.

11. The portable communication apparatus of claim 6 wherein the broadcast station broadcasts the live audio-visual content through a broadcast signal, and wherein the broadcast signal is at least one of a radio frequency transmission signal, a cable transmission signal, and/or an internet protocol transmission signal.

12. The portable communication apparatus of claim 1 wherein the codec is configured to determine a transmission rate for encoding the live visual content signal and the unbalanced live audio content signal into the UDP streaming content signal, for transmitting the UDP streaming content to the remote terminal device at the second remote location over a 4G or higher network.

13. The portable communication apparatus of claim 12 wherein the codec is further configured to determine the transmission rate based on the quality of transmission of the UDP streaming content.

14. The portable communication apparatus of claim 13 wherein the codec determines the quality of the transmission of the UDP streaming content by determining a transmission error rate and wherein the codec determines the transmission rate by comparing the transmission error rate to a predetermined error threshold.

15. The portable communication apparatus of claim 14 wherein the codec is configured to determine a higher transmission rate if the transmission error rate is less than the predetermined error threshold and a lower transmission rate if the transmission error rate is greater than the predetermined error threshold.

16. The portable communication apparatus of claim 13 wherein the codec comprises memory, a processor and program code, wherein the program code running on the processor determines the transmission rate by determining a transmission error rate and looking up a respective transmission rate from a transmission rate table stored within the memory.

17. The portable communication apparatus of claim 1, further comprising:
a logo generator in communication with the input/output switch for generating a logo signal and for transmitting the logo signal to the input/output switch.

18. The portable communication apparatus of claim 17 wherein the input/output switch is configured to transmit the logo signal alone or together with the live video content signal to the codec.

19. The portable communication apparatus of claim 17 wherein the logo generator further comprises a IP input connector for receiving a logo graphic for use in generating the logo signal, and wherein the logo generator further comprises memory for storing the logo graphic.

20. The portable communication apparatus of claim 1 wherein the codec is further configured to encode priority meta data information representing that the UDP streaming content signal is live audio-visual content for communication to a broadcast carrier.

21. The portable communication apparatus of claim 20 further configured to transmit the priority meta data to a first communication apparatus configured to receive the priority meta data and determine that the source of the UDP streaming is a priority source based on the priority meta data, and wherein the first communication apparatus is further configured to transmit the UDP streaming content signal over a priority bandwidth of the 4G or higher network if the first communication apparatus determines that the source of the UDP streaming content signal is a priority source.

22. A terminal communication apparatus for facilitating transmission of live audio-visual content between a first location and a second remote location, comprising:
a carrier receiving unit for receiving UDP streaming content, representing live audio-visual content, from a remote portable communication apparatus at a first remote location over a 4G or higher network;
a codec in communication with the carrier receiving unit for receiving the UDP streaming content, for decoding the UDP streaming content signal into a broadcast video content signal, and for decoding the UDP streaming content into an unbalanced broadcast audio content signal;
an audio matching converter in communication with the codec for receiving the unbalanced broadcast audio content signal, for balancing the unbalanced broadcast audio content signal into a balanced broadcast audio content signal, and for transmitting the balanced broadcast audio content signal to a broadcast signal generation device; and,
an input/output switch for receiving the broadcast video content signal, and for transmitting the broadcast video content signal to the broadcast signal generation device.

23. The terminal communication apparatus of claim 22 wherein the carrier receiving unit is a 4G or higher wireless modem.

24. The terminal communication apparatus of claim 22, further comprising:
a router in communication with the codec and the carrier receiving unit for receiving the UDP streaming content and for routing the UDP streaming content to the codec.

25. The terminal communication apparatus of claim 22 wherein the live audio-visual content is captured by a camera at the first remote location.

26. The terminal communication apparatus of claim 22, further comprising:
a monitor in communication with the input/output switch for receiving a broadcasted video signal from the input/output switch for viewing the broadcasted audio-visual content as it is being broadcasted by a broadcast station at the second location.

27. The terminal communication apparatus of claim 22 wherein the input/output switch receives a broadcast video signal and transmits the broadcast video signal to the codec.

28. The terminal communication apparatus of claim 27, wherein the audio matching converter is provided for receiving the broadcast audio signal and for unbalancing the broadcast audio signal into unbalanced broadcast audio signal.

29. The terminal communication apparatus of claim 28 wherein the codec is in communication with the audio matching converter and the input/output switch, for receiving the unbalanced broadcast audio signal and the broadcast video signal, and for encoding the unbalanced broadcast audio signal and the broadcast video signal into a broadcast signal in UDP streaming format, representing broadcasted video content.

30. The terminal communication apparatus of claim 22 wherein the broadcast station at the second location broadcasts the live audio-visual content through a broadcast signal, and wherein the broadcast signal is at least one of a radio frequency transmission signal, a cable transmission signal, and/or an internet protocol transmission signal.

31. The terminal communication apparatus of claim 22 wherein the codec is configured to determine a transmission rate for encoding the unbalanced broadcast audio signal and the broadcast video signal into the broadcast signal in UDP streaming format, for transmitting the broadcast signal in UDP streaming format to the remote portable communication apparatus at the first remote location over a 4G or higher network.

32. The terminal communication apparatus of claim 31 wherein the codec is further configured to determine the transmission rate based on the quality of transmission of the broadcast signal in UDP streaming format.

33. The terminal communication apparatus of claim 32 wherein the codec determines the quality of the transmission of the UDP streaming content by determining a transmission error rate and wherein the codec determines the transmission rate by comparing the transmission error rate to a predetermined error threshold.

34. The portable communication apparatus of claim 33 wherein the codec is configured to determine a higher transmission rate if the transmission error rate is less than the predetermined error threshold and a lower transmission rate if the transmission error rate is greater than the predetermined error threshold.

35. The portable communication apparatus of claim 31 wherein the codec comprises memory, a processor and program code, wherein the program code running on the processor determines the transmission rate by determining a transmission error rate and looking up a respective transmission rate from a transmission rate table stored within the memory.

36. The terminal communication apparatus of claim 22 wherein the codec is configured to encode the unbalanced broadcast audio signal and the broadcast video signal into the broadcast signal in UDP streaming format, in a resolution which is less than the resolution of the UDP streaming content, representing live audio-visual content by the carrier receiving unit from the remote portable communication apparatus at the first remote location.

37. A system for facilitating transmission of live audio-visual content between a first location and a second remote location, comprising:
a first communication apparatus for receiving a UDP streaming content signal from a portable communication apparatus, the portable communication apparatus comprising:
an input/output switch for receiving a live video content signal;
an audio matching converter for receiving a live audio content signal and for unbalancing the live audio content signal;
a codec in communication with the input/output switch for receiving the live video content signal transmitted from the input/output switch and for receiving the unbalanced live audio content signal, and for encoding the live visual content signal and the unbalanced live audio content signal into a UDP streaming content signal; and,
a 4G or higher wireless modem in communication with the codec for receiving the UDP streaming content and for transmitting the UDP streaming content to a remote terminal device at a second remote location over a 4G or higher network;
a second communication apparatus for transmitting the UDP streaming content signal to a terminal communication apparatus received from the first communication apparatus, wherein the terminal communication apparatus comprises:
a carrier receiving unit for receiving UDP streaming content, representing live audio-visual content, from a remote portable communication apparatus at a first remote location over a 4G or higher network;
a codec in communication with the carrier receiving unit for receiving the UDP streaming content, for decoding the UDP streaming content signal into a broadcast video content signal, and for decoding the UDP streaming content into an unbalanced broadcast audio content signal;
an audio matching converter in communication with the codec for receiving the unbalanced broadcast audio content signal and for balancing the unbalanced broadcast audio content signal into a balanced broadcast audio content signal; and,
an input/output switch for receiving the broadcast video content signal, and for transmitting the broadcast video content signal to a broadcast signal generation device, wherein the audio matching converter transmits the balanced broadcast audio content signal to the broadcast signal generation device;
wherein the first communication apparatus is configured to determine an IP address of the source of the UDP streaming content signal based on meta data within the UDP streaming content signal, wherein the first communication apparatus is further configured to determine whether the source of the UDP streaming content signal is a priority source based on the IP address of the source, and wherein the first communication apparatus is further configured to transmit the UDP streaming content signal over a priority bandwidth of the 4G or higher network if the first communication apparatus determines that the source of the UDP streaming content signal is a priority source.

38. A portable communications apparatus for facilitating transmission of live audio-visual content between a first location and a second remote location, comprising:
a housing having a first housing portion and a second housing portion forming a housing interior;
the housing having disposed thereon a plurality of connectors, the plurality of connectors comprising a video input connector, a video output connector, a first and second audio input connector and a first and second audio output connector;
a video monitor having a video display and disposed in an opening in the housing, wherein the video display is viewable from the exterior of the housing and a portion of the video monitor is disposed within the housing interior;
a video switch disposed in the housing interior, and communicatively connected to the video input connector, the video output connector, and the video monitor;
an audio matching convertor disposed in the housing interior and communicatively connected to the first and second audio input connectors and the first and second audio output connectors;
a codec disposed in the housing interior and communicatively connected to the audio matching convertor and the video switch;
a modem disposed in the housing interior; and,
a router disposed in the housing interior, wherein the router is communicatively connected to the codec and the modem.

39. The portable communications apparatus of claim 38 further comprising a battery connector disposed on the housing.

40. The portable communications apparatus of claim 38 further comprising a plurality of water-resistant outlet boxes, each of the outlet boxes enclosing one of the video input, video output, audio input and audio output connectors.

41. The portable communications apparatus of claim 38 further comprising a logo generator and a video display switch, wherein the video display switch permits a user to select between a plurality of video sources, the plurality of video sources comprising a camera connected to the video in connector, a remote terminal device connected to the portable communications apparatus by a 4 G communications network, and the logo generator.

42. The portable communications apparatus of claim 38 further comprising an Ethernet port disposed on the housing and communicatively connected to the router.

43. The portable communications apparatus of claim 38 further comprising an antenna connector disposed on the housing and in communicative connection with the modem.

44. The portable communications apparatus of claim 38 further comprising:
a first housing portion edge on the first housing portion, the first housing portion edge forming a plane and having a channel formed therein;
a gasket located in the channel of the first housing portion edge;
a second housing portion edge on the second housing portion, the second housing portion edge forming a plane;
a hinge connecting the first housing portion and the second housing portion;
wherein the first and second housing portions can be rotated about an axis formed by the hinge into a closed position such that when the first and second housing portions are in the closed position, wherein the gasket contacts the second housing portion edge, for forming a water resistant interface between the first housing portion and the second housing portion.

45. The portable communications apparatus of claim 44 further comprising a latch for retaining the first and second housing portions in the closed position.

46. The portable communications apparatus of claim 38 wherein the video monitor interfaces with the opening in the housing to form water resistant seal, thereby preventing moisture from entering the interior of the housing through the opening.

47. A wearable portable communications apparatus for facilitating transmission of live audio-visual content between a first location and a second remote location, comprising:
a housing having a first housing portion and a second housing portion forming a housing interior;
the housing having disposed thereon a plurality of connectors, the plurality of connectors comprising a video input connector, a video output connector, a first and second audio input connector and a first and second audio output connector;
a video monitor having a video display and disposed in an opening in the housing, wherein the video display is viewable from the exterior of the housing and a portion of the video monitor is disposed within the housing interior;
a video switch disposed in the housing interior, and communicatively connected to the video input connector, the video output connector, and the video monitor;
an audio matching convertor disposed in the housing interior and communicatively connected to the first and second audio input connectors and the first and second audio output connectors;
a codec disposed in the housing interior and communicatively connected to the audio matching convertor and the video switch;
a modem disposed in the housing interior; and,
a router disposed in the housing interior, wherein the router is communicatively connected to the codec and the modem.

48. The wearable portable communications apparatus of claim 47 further comprising a first strap attached to the housing for attaching the apparatus around a user's waist.

49. The wearable portable communications apparatus of claim 47 further comprising a first and second strap attached to the housing, wherein the first and second straps can be fitted over a user's shoulders for attaching the apparatus to the user.

50. The wearable portable communications apparatus of claim 47 further comprising a receiving pouch at least partially enclosing the housing and having a first and second strap attached to the receiving pouch, wherein the first and second straps can be fitted over a user's shoulders for attaching the apparatus to the user.

51. The wearable portable communications apparatus of claim 50 wherein the receiving pouch further comprises:
a first opening corresponding to at least one of the video input connector, the video output connector, the first and second audio input connector and the first and second audio output connector; and,
a second opening corresponding to the video monitor.
